(19) United States
(12) Patent Application Publication
(10) Pub. No.: US 2026/0263970 A1
(43) Pub. Date: Sep. 10, 2026

(54) Filter Element And Filter Device

(71) Applicant: HYDAC Filtertechnik GmbH, Sulzbach / Saar (DE)

(72) Inventors: Volker Backes, Marpingen (DE); Dirk Röder, Saarbrücken (DE)

(73) Assignee: HYDAC Filtertechnik GmbH, Sulzbach / Saar (DE)

(21) Appl. No.: 18/875,641

(22) PCT Filed: Aug. 7, 2023
(86) PCT No.: PCT/EP2023/071861

§ 371 Date: Dec. 16, 2024

(30) Foreign Application Priority Data
Sep. 12, 2022 (DE) 10 2022 123 191.7

(51) Int. Cl. B01D 29/19

(52) U.S. Cl. CPC B01D 29/19; B01D 2201/304; B01D 2201/32; B01D 2201/34

(57) ABSTRACT

Disclosed is a filter element, at least comprising an element material which extends between two end caps and at least one end cap of which has a receiving part for receiving the element material and a connecting part for connection to a housing part. Both the receiving part and the connecting part having on the inner circumference through-openings for the passage of fluid which are offset from one another relative to the longitudinal axis of the filter element. An offset step is arranged between the receiving part and the connecting part and also has a through-opening. The free cross-sections of the through-openings of the receiving part, connecting part and offset step, which each pass perpendicularly through the longitudinal axis of the filter element, are the same.

### CROSS-REFERENCE TO RELATED APPLICATIONS

This application claims priority to German Patent Application No. DE 10 2022 123 191.7, filed on Sep. 12, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter element, at least comprising an element material, which extends between two end caps, at least one end cap of which has a receiving part for receiving the element material and a connecting part for connection to a housing part, both the receiving part and the connecting part having, on the inner circumference, through openings for the passage of fluid which are offset from one another relative to the longitudinal axis of the filter element. The disclosure also relates to a filter device.

EP 2 490 784 B1 discloses a filter element for use in an associated filter device, said element comprising an end cap at at least one end forming an enclosure for a relevant end rim of the filter material, which end cap, for fixing the location of the filter element in a functional position, can be fixed on an element receiver on the bottom part of the filter housing, wherein the end cap is provided with a shape irregularity on parts that, in the functional position, come into engagement with parts of the element receiver in the relevant filter housing, said shape irregularity being matched to a shape irregularity located on parts of the element receiver such that, when the shape irregularities are aligned in a positional relationship with respect to one another, engagement between the end cap and the element receiver and thus movement of the filter element into the functional position is enabled, wherein the end cap comprises a connector that extends into an inner filter cavity surrounded by a fluid-permeable support tube and engages in one tube connector of the element receiver in the filter housing in the functional position of the filter element, and wherein the opening cross-section of the connector, as the shape irregularity associated with the end cap, is adapted to the non-circular and asymmetrical outer contour of the tube connector of the element receiver forming the shape irregularity of the element receiver. As such, the through opening on the inner circumference of the receiving part with the filter element and the through opening on the inner circumference of the connecting part for connecting to a housing part are offset with respect to one another in relation to their respective longitudinal axis.

By virtue of this fact, a relevant filter element can only be moved into the functional position on condition that complementary shape features on the element receiver and end cap are adapted to one another such that they permit engagement when mutually aligned accordingly. This provides that the filter device can only be operated with a filter element that is provided for a respective special use and fulfils the applicable specifications to provide operating reliability.

Due to the thus defined specified rotation position of the filter element in the filter housing, this thus provides the further possibility, in a filter housing that comprises a side fluid inlet adjacent to the end cap of the filter element located in functional position, to provide a shielding part on the end cap, said shielding part extending along the outside of the filter material of the filter element and, in the functional position of the filter element, covers the region of the fluid inlet as impact protection. The fixed rotation position ensures that the impact protection is reliably in the inflow region of the filter element in this case.

### SUMMARY

A need exists to provide an improved solution, allowing a positioning of a filter element inside a filter housing such that pressure losses are reduced during filtration operation.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example filter device in its entirety in the form of a longitudinal section;

FIG. 2 is a view of an example filter device rotated forwards through 90° compared to the viewing direction shown in FIG. 1;

FIG. 3 is a partial half-section partial view of an example filter element as can theoretically be used in the filter device according to FIGS. 1 and 2; and

FIGS. 4, 5 and 6 show perspective views from beneath, from the side and a plan view from beneath of an example connecting part for receiving a filter element according to the drawings shown in FIGS. 1 and 3.

### DESCRIPTION

In some embodiments, it is provided that the filter element comprises an offset step between the receiving part and the connecting part, which also includes a through opening. The free cross-sections of the through openings of the receiving part, connecting part and offset step, which each pass perpendicularly through the longitudinal axis of the filter element, are the same. Due to the aforementioned free cross-sections being the same, flow losses when discharging the filtrate stream from the filter element are avoided, wherein a stream of unfiltered medium is flowing through the element material of the filter element from the outside to the inside for particle cleaning purposes.

Furthermore, the offset step on the filter element allows the inner space of the filter element with the filtrate volume to be spatially separated from its filtrate discharge point such that filtrate receipt and filtrate discharge are functionally present at different locations on the filter element.

In conjunction with an example filter housing of a filter device, this makes it possible to attach the filter element in its entirety off-centred inside the filter housing, and such that, on the inflow side of the filter housing via which the stream of unfiltered medium is supplied, an enlarged annular gap arises between the outer circumference of the filter element and the adjacent inner circumference of the assigned filter housing, wherein, on the rear side of the element, i.e., on the side facing away from the inflow side, this annular gap is reduced, which leads to lower flow losses, in other words to a lower AP than if the element is received in a centred manner and coaxially in relation to its longitudinal axis while retaining equal wall distances from the filter housing. This therefore has no parallel in the prior art.

For example, it is provided that the respective through opening of the receiving part and the connecting part is formed by a circular ring-shaped hollow cylinder, the hollow cylinder of the receiving part runs concentrically with respect to the longitudinal axis of the filter element, the longitudinal axis of the hollow cylinder of the connecting part with an offset runs parallel to the longitudinal axis of the filter element, and the offset step spans an annular cavity, the longitudinal axis of which intersects the two other longitudinal axes of the receiving part and the connecting part with a predefinable offset angle, which is for example between 15° to 45°, or for example 35°. As such, both the receiving part and the connecting part and the offset step lying in between can be accommodated in a particularly space-saving manner in an end cap of the element material, by means of which the filtrate stream can be discharged from the filter element.

In some embodiments, it is provided that one end cap comprises a flow divider, which, starting from one receiving part, extends over a predefinable distance along at least one part of the outer circumference of the element material. For example, in this case, the flow divider is configured in the form of a bowl and covers part of the element material, the predefinable distance being selected such that the element material is protected or relieved respectively when fluid flows onto the element material from an inflow side. Due to the fixed rotation position of the filter element inside a filter housing, this ensures that the resulting impact protection is in the inflow region of the filter element and is for example able to distribute the unfiltered medium stream in a uniform manner in the direction of the element material.

In some embodiments, it is provided that the flow divider is furnished with fluid passages running in a channel-like fashion for improved flow guidance. In this case, the channel-like fluid passages are for example subdivided into at least two groups which extend in a V-shape away from a central axis of the flow divider, which is thus for example configured to be wedge-shaped and allows a uniform flow distribution of the inflowing fluid in two different directions. By virtue of the fact that the flow divider does not form a closed shield body as impact protection, thanks to the channel-like fluid passages, the element material located behind them continues to be in fluid contact and can thus carry out effective particle filtration even in the covered region.

The combination of a filter element with the inflow protection or flow divider respectively leads to flow optimisation and to a more homogeneous flow distribution or throughflow of the complete filter element during filtration operation. As part of a simplified operation to replace a spent filter element with a new element, it is provided that the respective connecting part of such a filter element has an annular groove on its outer circumference to receive a standardised sealing apparatus.

In some embodiments, it is provided that one end cap, arranged parallel to the longitudinal axis of the element material in the region of the offset step, comprises individual longitudinal ribs spaced apart from one another, which are enclosed by a polygon as a notional enclosing end. The aforementioned polygon shape as the enclosing end of the longitudinal ribs supports precise positioning of the filter element inside the element receiver of a filter device.

The disclosure also relates to a filter device having a filter housing in which a filter element as described herein is received, wherein the filter element is received asymmetrically in the filter housing by means of an end cap such that, on the inflow side with the unfiltered medium stream, an enlarged annular gap is created and on the side facing away therefrom a reduced annular gap is created between the filter element and the filter housing. As such, this leads to an asymmetrical element receiver as well as flow guidance in the associated filter housing with a housing cavity formed in a substantially circular-cylindrical manner. For example, in this case it is provided that the inflow side in the filter housing for supplying the unfiltered medium stream is covered by the flow divider of the filter element at a predefinable distance.

The filter element and an associated filter device is discussed in greater detail below with reference to further embodiments according to the FIGS. The FIGS. are schematic and not necessarily to scale.

Specific references to components, process steps, and other elements are not intended to be limiting. Further, it is understood that like parts bear the same or similar reference numerals when referring to alternate FIGS.

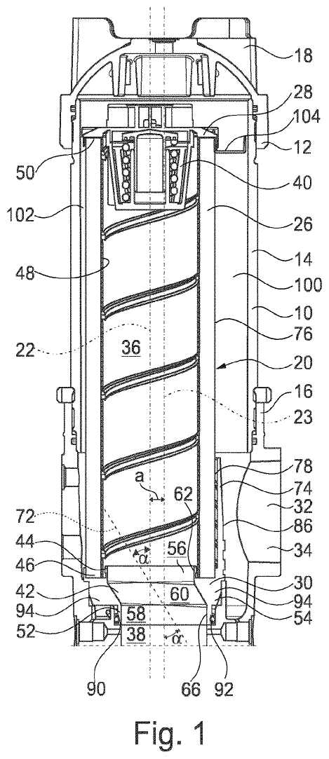

A filter housing in the shape of a hollow cylinder referred to in its entirety in FIG. 1 as 10 comprises an upper part 12, a middle part 14 and a base part 16 which are screwed to one another. However, in particular the middle part 14 may also be configured to be a single piece with the base part 16. The filter device shown in FIG. 1 is shown in its operating position and the upper end, in the form of the top part 12, opposite the base part 16 can be closed by a screwed-on housing lid 18. A filter element referred to in its entirety as 20 is received in a replaceable manner in the filter housing 10, the longitudinal axis 22 of the filter element 20 extending parallel to the longitudinal axis 23 of the filter housing 10.

In the customary manner, the filter element 20 comprises an element material 26 which extends between an upper end cap 28 and a lower end cap 30. The element material 26 serves to clean particulate contamination from a fluid stream. To guide the fluid stream, the filter housing 10 or the bottom housing part 16 respectively comprises an inflow side 32 for supplying an unfiltered medium stream, the inflow side 32 being formed by a circular housing opening 34 in the base part 16. Starting from this inflow side 32, the unfiltered medium is divided along the outer circumference of the filter element 20, and after flowing through the element material 26 from the outside to the inside, the thus cleaned fluid stream passes as filtrate to the inside 36 of the filter element 20. As a continuation of the fluid stream, the filtrate located on the inside 36 of the filter element 20 then passes to the bottom discharge side 38 of the filter housing 10. While, in the usual design, the upper end cap 28 comprises a bypass valve 40, which allows a bypass flow from the unfiltered medium or raw sides directly to the filtrate or clean side by bypassing the element material 26 when the element material 26 is clogged or blocked respectively, the lower end cap 30 has a specially configured passage region 42 to guide the filtrate stream. This passage region 42 is connected in a permanently fluid-conveying manner to the filtrate or clean side or the inside 36 respectively of the filter element 20. As such, the lower end cap 30 can be subdivided into individual parts with different regions for different purposes. Thus, in the customary manner, the lower end cap 20 comprises a receiving part 44 for receiving the element material 26. For this purpose, the receiving part 44 has an annular adhesive bed 46 running on the outer circumference, by means of which the lower end of the element material 26, which is free on its end face, is glued. A fluid-permeable support tube 48 which is generally arranged on the inner circumference of the hollow cylindrical element material 26 is adhesively fixed in this region, together with the element material 26, also in the adhesive bed 46 of the receiving part 44. The upper end region of the element material 26 and support tube 48 is also securely connected to the upper end cap 28 by means of a further adhesive bed 50, similar to the lower end cap 30.

Furthermore, the lower end cap 30 comprises a connecting part 52 for connecting the filter element 20 to the bottom housing part or base part 16 respectively. An offset step 54 is provided as an additional offset part between the receiving part 44 and the connecting part 52. Both the receiving part 44 and the connecting part 52 as well as the offset step 54 as a so-called offset part are integral parts of the lower end cap 30 and in particular are formed from a plastics moulding part. All the aforementioned parts 44, 52 and 54 have individual through openings 56, 58 and 60 on their inner circumference which transition continuously into one another. In particular, the free cross-sections of the individual through openings 56, 58, 60 of the receiving part 44, connecting part 52 and offset step 54, which in each case pass perpendicularly through the longitudinal axis 22 of the filter element 20, are the same.

The respective through opening 56, 58 of the receiving part 44 or connecting part 52 respectively is formed by a circular ring-shaped hollow cylinder 62, 66 of the lower end cap 30, the hollow cylinder 62 of the receiving part 44 running concentrically with respect to the longitudinal axis 22 of the filter element 20. The hollow cylinder 66 of the connecting part 52, on the other hand, runs concentrically with respect to the longitudinal axis 23 of the filter housing 10. The offset step 54 in turn spans an annular cavity 70 with a delimiting wall that runs obliquely, the longitudinal axis 72 of the cavity intersecting the two other longitudinal axes 22 and 23, which pass through the centre of the receiving part 44 or connecting part 52 respectively at a predefined offset angle α, which in this case is approximately 35°; but may also move in angular ranges between 15° to 45°.

As is also shown in the FIGS., one end cap 30 comprises a flow divider 74, which, starting from the receiving part 44, extends over a predefinable distance along at least one part of the outer circumference 76 of the element material 26. The element material 26 is for example laid in individual filter pleats and the notional outer circumference of the resulting filter pleats (not shown) delimits an annular gap 78 with the inner circumference of the flow divider 74.

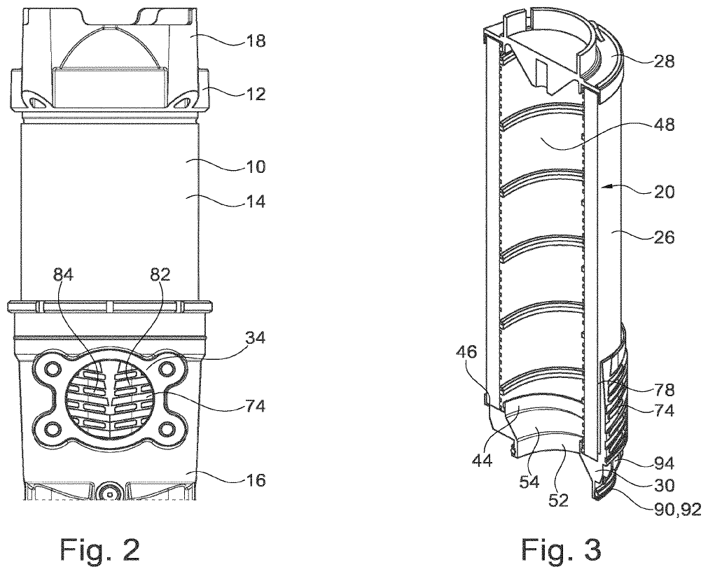

As shown particularly in FIG. 4, the flow divider 74 is configured in the form of a bowl and coverage of the element material 26 is selected such that the element material 26 is protected when fluid flows onto the element material 26 from the inflow side 32. To this end, as shown in FIGS. 1 and 2, the flow divider 74 extends over the circular ring-shaped housing opening 34 forming the inflow side 32 with unfiltered medium from the inside, while observing a predefinable distance.

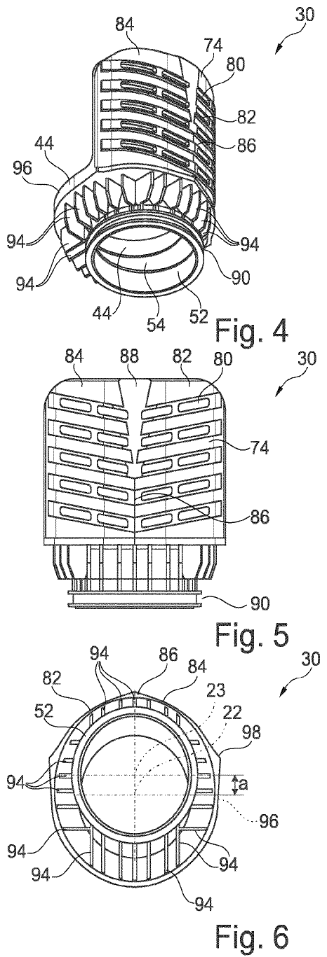

As is particularly evident in FIGS. 4 and 5, the flow divider 74 is provided with fluid passages 80 running in a channel-like fashion for improved flow guidance. In this process, the channel-like fluid passages 80 are subdivided into at least two groups 82, 84 which extend in a V-shape away from a vertical central axis 86 of the flow divider 74, which is for example configured to be wedge-shaped and allows a uniform flow distribution of the inflowing fluid in two different directions, specifically towards one group 82 and towards the other group 84. As shown on FIG. 5, a V-shaped middle region 88 may be configured, starting from the underlying central axis 86 without channel-like fluid passages 80 such that, in this region, which is also V-shaped, a solid shield is formed as impact protection. The channel-like fluid passages 80 are in each case formed by strip or bar-shaped channels in the shield of the flow divider 74 and the elongated fluid passages 80 are incorporated in the depression of these channels in the form of continuous longitudinal grooves such that, starting from the inflow side 32, fluid at a predefined pressure entering the filter housing 10 is passed through the individual channel-like fluid passages 80 in the form of an orifice, said fluid, viewed in the radial direction, coming into contact with the element material 26 via the annular gap 78, such that, in this manner, a uniform flow onto the individual filter pleats is guaranteed without causing pressure peaks which might damage the element material 26.

Furthermore, according to the drawings in FIGS. 1, 3, 4 and 5, the connecting part 52 has an annular groove 90 on the outer circumference of its lower end region for receiving a sealing apparatus 92, in the form of an O-ring seal. In an embodiment which is not shown in further detail, it is also possible to configure a corresponding sealing apparatus 92 from an injected sealing rim such that elastomer-free sealing is possible. In FIG. 1, however, via the respective sealing apparatus 92, the filter element 20 is guided in a replaceable manner in the lower base region, i.e., with its lower end cap 30, sealed in the base part 16 of the filter housing 10. To ensure a corresponding replacement of a contaminated filter element 20 with a new element, only the upper part 12 in the form of the housing lid 18 needs to be screwed off the middle part 14 of the filter housing 10, and as such, the filter element 20 in its entirety can be removed by hand from the top such as to obtain a filter element that is located outside the filter housing 10, as shown in FIG. 3, with the bypass valve 40 being omitted from the corresponding filter element 20 and the upper end cap 28 thus being configured to be closed. A new element is then inserted in the reverse order and the device can be returned to operation again.

As is particularly evident from FIG. 4 to 6, the lower end cap 30 configured as a plastics moulded part comprises individual longitudinal ribs 94 of varying structural length, protruding downwards, beneath the receiving part 44, which are enclosed as notional enclosing ends 96 by a polygon, as shown by dashes on FIG. 6. In this process, the enclosing ends 96 follow the circumferential edge 98 of the lower end cap 30 at least partially and the aforementioned longitudinal ribs 94 reinforce, in particular, the transition region between the receiving part 44 and the connecting part 52 in the form of the offset step 54, in which region the longitudinal ribs 94 themselves enclose the offset step 54. The individual longitudinal ribs 94 are in this case, as shown in FIG. 6, combined in four different groups, ‘top, bottom, right and left’, the right and left group comprising longitudinal ribs 94 with the same configuration and otherwise the longitudinal ribs 94 which are spaced apart from one another, arranged vertically in a group running parallel to one another, are in notional extension perpendicular to an adjacent group, once again with its notional extension.

In addition to reinforcing the lower end cap 30, the longitudinal rib construction also permits accurate positioning of the filter element 20 inside the filter housing 10, in that the flow divider 74 is arranged in a defined adjacent manner opposite the inflow side 32 with the housing opening 34.

Due to the asymmetrical configuration of the lower end cap 30, the filter element 20 can be accommodated in the filter housing 10 in an offset manner according to the longitudinal section view in FIG. 1, i.e., the longitudinal axis 22 of the filter element 20 has an offset a opposite the longitudinal axis 23 of the filter housing 10 and, as such, this then leads to an enlarged, gap-shaped annular space 100 on the inflow side 32 with the unfiltered medium stream and, on the opposite side facing away, a reduced gap-shaped annular space 102 is created between the filter element 20 and the filter housing 10 such that, in its entirety, the filter element 20 is received in an asymmetrical installation manner in the filter housing 10. Accordingly, an enlarged distance between the flow divider 74 and the inflow side 32 also automatically arises in the filter housing 10.

With the solution according to the teachings therein, a standard filter element can be used which is equipped with an asymmetrical lower end cap 30 and can be inserted, in combination with an injected inflow protection in the form of the flow divider 74, into a standard filter housing 10. As already described, the insertion ribs in the form of the longitudinal ribs 94 on the lower end cap 30 are configured in the form of a so-called O-ring cap as a polygon, such that the filter element 20 can always be fitted in its entirety in the exact position in the filter housing 10, guaranteeing that the flow divider 74 is always precisely at the filter inlet, in the form of the circular ring-shaped housing opening 34, which forms the inflow side 32 of the device. The illustrated offset positioning of the filter element 20 outside the housing centre, i.e., outside the longitudinal axis 23 of the filter housing 10, leads to an enlarged gap-shaped annular space 100 between the unfiltered medium inlet 34 and the filter element 20, as a result of which Ap is reduced by lower flow losses.

The combination of the element 20 with the inflow protection, i.e., flow divider 74, leads to flow optimisation and to a more homogeneous flow distribution or throughflow of the complete filter element 20 along its longitudinal axis 22. Furthermore, the element 20 is protected in the inlet region of the fluid. In addition, it is possible, by using a special mat structure in combination with the new asymmetrical cap 30, to increase the possibility the hydraulic load of the element and thus build it smaller, while retaining the same filter capacity in comparison to a standard symmetrical construction. To ensure that the filter element 20, as shown in FIG. 1, is also securely received in its asymmetrical position in the filter housing 10 in the region of its upper end cap 28, the end cap 28 may have a segment-shaped widening 104, which is configured as a shaped sheet metal part with an upwardly protruding rim and can be supported on the inner circumference of the middle part 14 of the filter housing 10 such that the filter element 20 is received in a functionally reliable manner in the filter housing 10 via its two end caps 28, 30.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-10. (canceled)

11. A filter element, comprising at least an element material, which extends between two end caps, at least one end cap of which has a receiving part for receiving the element material and a connecting part for connection to a housing part, both the receiving part and the connecting part having, on the inner circumference, through openings for the passage of fluid which are offset from one another relative to the longitudinal axis of the filter element, wherein an offset step is arranged between the receiving part and the connecting part and also has a through opening, and wherein the free cross-sections of the through-openings of the receiving part, connecting part and offset step, which each pass perpendicularly through the longitudinal axis of the filter element, are the same.

12. The filter element of claim 11, wherein the respective through opening of the receiving part and the connecting part is formed by a circular ring-shaped hollow cylinder, wherein the hollow cylinder of the receiving part runs concentrically with respect to the longitudinal axis of the filter element, wherein the hollow cylinder of the connecting part runs concentrically with respect to the longitudinal axis of the filter housing with an offset parallel to the longitudinal axis of the filter element, and wherein the offset step spans an annular cavity, the longitudinal axis of which intersects the two other longitudinal axes with a predefinable offset angle α.

13. The filter element of claim 11, wherein one end cap comprises a flow divider, which, starting from the receiving part, extends over a predefinable distance along at least one part of the outer circumference of the element material.

14. The filter element of claim 13, wherein the flow divider is configured in the form of a bowl and covers part of the element material and wherein the predefinable distance is selected such that the element material is protected when fluid flows onto the element material from the inflow side.

15. The filter element of claim 13, wherein the flow divider is provided with fluid passages running in a channel-like fashion for improved flow guidance.

16. The filter element of claim 15, wherein the channel-like fluid passages are subdivided into at least two groups which extend in a V-shape away from a central axis of the flow divider.

17. The filter element of claim 11, wherein the connecting part comprises an annular groove for receiving a sealing apparatus in its outer circumference.

18. The filter element of claim 11, wherein one end cap, arranged parallel to the longitudinal axis of the filter element in the region of the offset step, comprises individual longitudinal ribs spaced apart from one another, which are enclosed by a polygon as a notional enclosing end.

19. A filter device having a filter housing in which a filter element of claim 11 is received, wherein the filter element is received asymmetrically in the filter housing using an end cap such that, on the inflow side with the unfiltered medium stream, an enlarged space is created and, on the opposite side facing away, a reduced annular space is created between the filter element and the filter housing.

20. The filter device of claim 19, wherein the inflow side in the filter housing for supplying the unfiltered medium stream is covered by a flow divider of the filter element at a predefinable distance.

21. The filter element of claim 12, wherein the predefinable offset angle α is between 15 to 45°.

22. The filter element of claim 12, wherein the predefinable offset angle α is 35°.

23. The filter element of claim 15, wherein the channel-like fluid passages are subdivided into at least two groups which extend in a V-shape away from a central axis of the flow divider, which is configured to be wedge-shaped and allows a uniform flow distribution of the inflowing fluid in two different directions.

24. The filter device of claim 19, wherein the respective through opening of the receiving part and the connecting part is formed by a circular ring-shaped hollow cylinder, wherein the hollow cylinder of the receiving part runs concentrically with respect to the longitudinal axis of the filter element, wherein the hollow cylinder of the connecting part runs concentrically with respect to the longitudinal axis of the filter housing with an offset parallel to the longitudinal axis of the filter element, and wherein the offset step spans an annular cavity, the longitudinal axis of which intersects the two other longitudinal axes with a predefinable offset angle α.

25. The filter device of claim 19, wherein one end cap comprises a flow divider, which, starting from the receiving part, extends over a predefinable distance along at least one part of the outer circumference of the element material.

26. The filter device of claim 19, wherein the flow divider is configured in the form of a bowl and covers part of the element material and wherein the predefinable distance is selected such that the element material is protected when fluid flows onto the element material from the inflow side.

27. The filter device of claim 19, wherein the flow divider is provided with fluid passages running in a channel-like fashion for improved flow guidance.

28. The filter device of claim 19, wherein the channel-like fluid passages are subdivided into at least two groups which extend in a V-shape away from a central axis of the flow divider.

29. The filter device of claim 19, wherein the connecting part comprises an annular groove for receiving a sealing apparatus in its outer circumference.

30. The filter device of claim 19, wherein one end cap, arranged parallel to the longitudinal axis of the filter element in the region of the offset step, comprises individual longitudinal ribs spaced apart from one another, which are enclosed by a polygon as a notional enclosing end.
